(19) United States
(12) Patent Application Publication
(10) Pub. No.: US 2015/0066650 A1
(43) Pub. Date: Mar. 5, 2015

(54) Method and Apparatus for Advertisements in Mobile Content Distribution Systems

(71) Applicant: Nokia Corporation, Espoo (FI)

(72) Inventors: Dong E. Liu, Beijing (CN); Hao Yang, San Jose, CA (US); Jilei Tian, Beijing (CN)

(21) Appl. No.: 14/372,091

(22) PCT Filed: Feb. 3, 2012
(86) PCT No.: PCT/CN2012/070879

§ 371 Date: Aug. 6, 2014

(51) Int. Cl. G06Q 30/02

(52) U.S. Cl. CPC G06Q 30/0267
USPC 705/14.64

(57) ABSTRACT

An approach is provided for optimally matching advertisements to content items for targeted consumers using the content distribution characteristics. A distribution processor determines one or more distribution characteristics of one or more first content items that are distributed among one or more devices. The distribution processor then processes and/or facilitates processing of the one or more distribution characteristics to cause, at least in part, a selection of one or more second content items. In one scenario, the one or more second content items may include advertisements. From there, the distribution processor processes and/or facilitates a processing of the one or more first content items to cause, at least in part, an embedding of the one or more second content items in the one or more first content items.

### BACKGROUND

Service providers and device manufacturers (e.g., wireless, cellular, etc.) are continually challenged to deliver value and convenience to consumers by, for example, providing compelling internet services. One area of interest has been the development of distributing content via peer-to-peer (P2P) systems. These systems using, for example, Bluetooth, may provide content item sharing without the need for an Internet connection, thus permitting sharing even with little Internet infrastructure. However, content distributed via such offline sharing often lacks monetized business model, more precisely, presenting advertisements tailored to target audiences. Accordingly, advertisement providers face technical challenges in reaching target users who receive content via offline, P2P systems.

### Some Example Embodiments

Therefore, there is a need for an approach for pairing advertisements to content items using distribution characteristics.

According to one embodiment, a method comprises determining one or more distribution characteristics of one or more first content items that are distributed among one or more devices. The method also comprises processing and/or facilitating a processing of the one or more distribution characteristics to cause, at least in part, a selection of one or more second content items. The method further comprises processing and/or facilitating a processing of the one or more first content items to cause, at least in part, an embedding of the one or more second content items in the one or more first content items.

According to another embodiment, an apparatus comprises at least one processor, and at least one memory including computer program code for one or more computer programs, the at least one memory and the computer program code configured to, with the at least one processor, cause, at least in part, the apparatus to determine one or more distribution characteristics of one or more first content items that are distributed among one or more devices. The apparatus is also caused to process and/or facilitate a processing of the one or more distribution characteristics to cause, at least in part, a selection of one or more second content items. The apparatus is further caused to process and/or facilitate a processing of the one or more first content items to cause, at least in part, an embedding of the one or more second content items in the one or more first content items.

According to another embodiment, a computer-readable storage medium carries one or more sequences of one or more instructions which, when executed by one or more processors, cause, at least in part, an apparatus to determine one or more distribution characteristics of one or more first content items that are distributed among one or more devices. The apparatus is also caused to process and/or facilitate a processing of the one or more distribution characteristics to cause, at least in part, a selection of one or more second content items. The apparatus is further caused to process and/or facilitate a processing of the one or more first content items to cause, at least in part, an embedding of the one or more second content items in the one or more first content items.

According to another embodiment, an apparatus comprises means for determining one or more distribution characteristics of one or more first content items that are distributed among one or more devices. The apparatus also comprises means for processing and/or facilitating a processing of the one or more distribution characteristics to cause, at least in part, a selection of one or more second content items. The apparatus further comprises means for processing and/or facilitating a processing of the one or more first content items to cause, at least in part, an embedding of the one or more second content items in the one or more first content items.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-20 and 36-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of pairing advertisements to content items using distribution characteristics, according to one embodiment;

FIG. 2 is a diagram of the components of a distribution processor, according to one embodiment;

FIG. 3 is a diagram of the components of an accessibility platform, according to one embodiment;

FIG. 4 is a flowchart of a process for pairing advertisements to content items using distribution characteristics, according to one embodiment;

FIG. 5 is a flowchart of a process for determining distribution characteristics of one or more content items, according to one embodiment;

FIG. 6 is a diagram of a scenario for updating advertisement-content item pairings, according to one embodiment;

FIGS. 7A-7E are diagrams of calculations for determining distribution characteristics utilized in the processes of FIGS. 4 and 5, according to various embodiments;

FIG. 8 is a diagram of hardware that can be used to implement an embodiment of the invention;

FIG. 9 is a diagram of a chip set that can be used to implement an embodiment of the invention; and

FIG. 10 is a diagram of a mobile terminal (e.g., handset) that can be used to implement an embodiment of the invention.

### DESCRIPTION OF SOME EMBODIMENTS

Examples of a method, apparatus, and computer program for pairing advertisements to content items using distribution characteristics are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

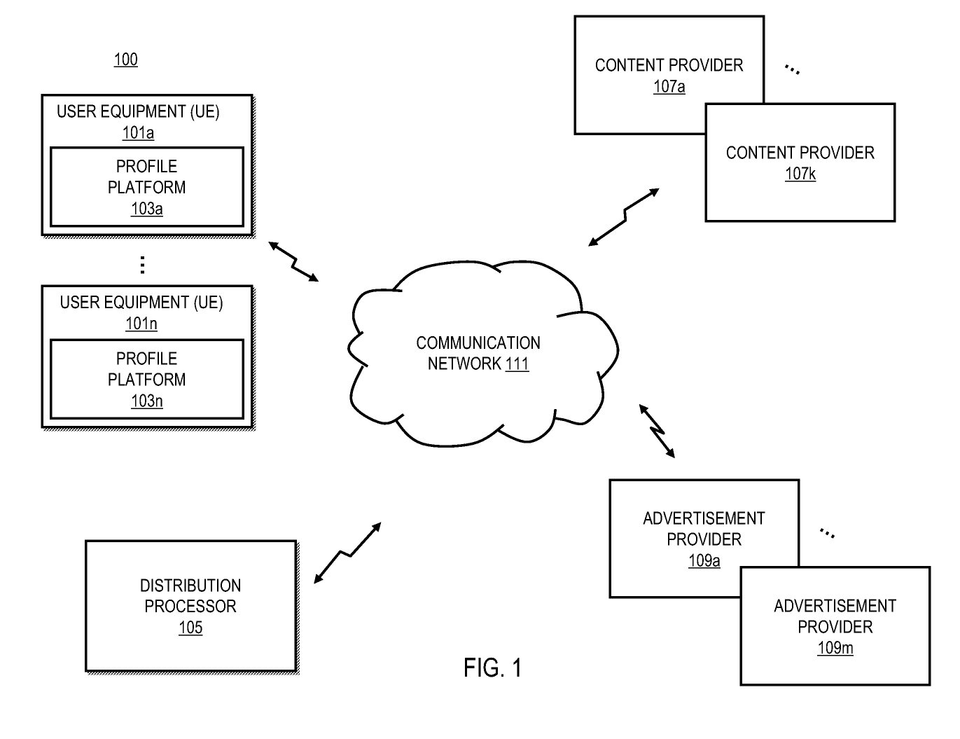

FIG. 1 is a diagram of a system capable of pairing one or more first content items to one or more second content items using distribution characteristics. In one embodiment, this could include pairing one or more content items to one or more advertisements using distribution characteristics. As discussed, content distributed via offline sharing often lacks advertisements or advertisements tailored to target audiences. Accordingly, device manufacturers and service providers face technical challenges in enabling their advertisements to reach target users who receive content via offline, P2P systems. The one or more content items may be, for example, an audio file, video file, song, picture, presentation, Internet web page, Internet link, document, database, book, map, point of interest, application, applet, computer program, service guide, or any combination thereof. The one or more advertisements may be, for example, an audio file, video file, song, picture, presentation, Internet web page, Internet link, document, database, book, map, point of interest, application, applet, computer program, service guide, or any combination thereof.

To address this problem, a system 100 of FIG. 1 introduces the capability to pair advertisements to content items using distribution characteristics. The system 100 may, for instance, enable advertisements to be distributed along with content items based on distribution characteristics of the content items. As shown in FIG. 1, the system 100 comprises a user equipment (UE) 101 (or UE 101a-101n) having connectivity to respective profile platforms 103, as well as a distribution processor 105, content providers 107 (or content providers 107a-107k), and advertisement providers 109 (or advertisement providers 109a-109m) via a communication network 111. The UEs 101 may include or have access to a profile platform 103 (or profile platform 103a-103n) to enable the UEs 101 to interact with the distribution processor 105, one or more content providers 107, one or more advertisement providers 109, and communication network 111. Profile platforms 103 may have access to user profiles associated with respective UEs 101. User profiles may include basic information about a user associated with one or more UEs 101a-101n, such as, gender, age, language, etc. User profiles may be generated in a variety of ways, including directly prompting users to provide information, obtaining user context information, integrating content of the profile platforms 103a-n, or some combination thereof.

In one embodiment, the system 100 may include a server and many clients (peers). In system 100, for instance, the distribution processor 105 may represent the server and the UEs 101 may represent the clients. In some embodiments, each of the UEs 101 may communicate with the distribution processor 105 through communication network 111, which may include online means (e.g., short message service (SMS), General Packet Radio Service (GPRS), etc.). Additionally, or alternatively, the UEs 101 may communicate with each other through communication network 111, which may include offline means (e.g. Bluetooth or other short-range wireless networks).

Meanwhile, content providers 107 may upload content items (and/or metadata pertaining to the content items) to the distribution processor 105 (e.g., with advertisements already embedded in the content items, without the advertisements embedded in the content items, etc.). In one scenario, clients may download songs (e.g., uploaded by musicians) directly from the server and/or from other clients. Advertisement providers 109 may also upload their advertisements (and/or metadata pertaining to the advertisements) to the distribution processor 105. The distribution processor 105 may then process the input from UEs 101, content providers 107, and advertisement providers 109 to output content item-advertisement pairings. In one embodiment, UEs 101 provide associated user profile information, content providers 107 submit content item distribution information, and advertisement providers 109 give target audience specifications to the distribution processor 105. The distribution processor 105 then creates, at least in part, content item-advertisement pairings with this information.

In some embodiments, an advertisement may be embedded in the content item as metadata, where UEs 101 may, for instance, require an application to interpret the metadata. In other embodiments, an advertisement may be of the same media as the content item, so that a separate application would not be necessary to interpret the advertisement. That is, the application utilized to process the content item may also process the advertisement.

In one scenario, an advertisement may be a picture, while a content item may be a song. A UE 101 may, for instance, display the advertisement picture on the user interface of the UE 101 while the song is playing. In another scenario, an advertisement may include an overlay on a content item, such as a picture overlay on a video content item, for instance. In yet another possible scenario, the advertisement may be of the same media as the content item. In this case, the UE 101 may play a paired advertisement preceding the downloaded content item. It is noted that, in certain embodiments, the system 100 may pair one or more advertisements to one or more content items regardless of whether the content item was previously paired with an advertisement.

For example, there may be a content item-advertisement relationship where one content item may embed, at most, one advertisement, as determined by distribution processor 105. To update the pairing relationships of content items and advertisements, the distribution processor 105 may, for instance, embed an advertisement in a content item previously without an embedded advertisement, remove an embedded advertisement from a content item where it was previously embedded, and/or change the advertisement embedded in a content item. As such, advertisements may stay current and the advertisement service (such as the advertisement providers 109) may continue to make money as new advertisements occupy advertising slots. In addition, updating the advertisement embedded in a content item may permit the system 100 to gather more input on the content item-advertisement relationship based on the content item distribution characteristics, thus providing the system with increasingly optimized pairings of advertisements to content items. Therefore, updates of the content item-advertisement relationship may occur when a new advertisement arrives, an old advertisement is expiring, when a significant amount of new data on content distribution characteristics have been gathered, etc.

By way of example, the communication network 111 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), near field communication (NFC), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

In one embodiment, the UEs 101 may receive a request from the distribution processor 105, content providers 107, advertisement providers 109, communication network 111, or any combination thereof, via the communication network 111 to build and transmit associated user profiles from profile platforms 103. As discussed above, profile platforms 103 may adjust and update user profiles according to user response and input, context information, or any combination thereof. In a further embodiment, content providers 107 may then receive a request from the distribution processor 105 for distribution characteristics regarding content items. In one scenario, the distribution characteristics include distribution history of one or more content items. The distribution processor 105 may also request target audience specifications from advertisement providers 109.

From the user profiles, content distribution history, and target audience specifications submitted through the communication network 111 by the profile platforms 103, content providers 107, and advertisement providers 109, respectively, the distribution processor 105 may determine one or more content item-advertisement relationships. After processing the relationships, the UEs 101, distribution processor 105, content providers 107, and advertisement providers 109, or any combination thereof; may cause, at least in part, one or more advertisements to be embedded in one or more content items so that the advertisements are distributed in the system along with the content items.

In one embodiment, the distribution processor 105 may update embedded advertisements where a content item lacks an advertisement or where previously embedded advertisement(s) are expired. Updates may also be based on increased accuracy of information collected by the profile platforms 103, distribution processor 105, content providers 107, advertisement providers 109, or some combination thereof, as more information is collected. In this way, system 100 may increase value for advertisement providers 109 in better ensuring that advertisements reach target audiences.

By way of example, the UE 101, profile platforms 103, distribution processor 105, content providers 107, and advertisement providers 109 communicate with each other and other components of the communication network 111 using well known, new or still developing protocols. In this context, a protocol includes a set of rules defining how the network nodes within the communication network 111 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

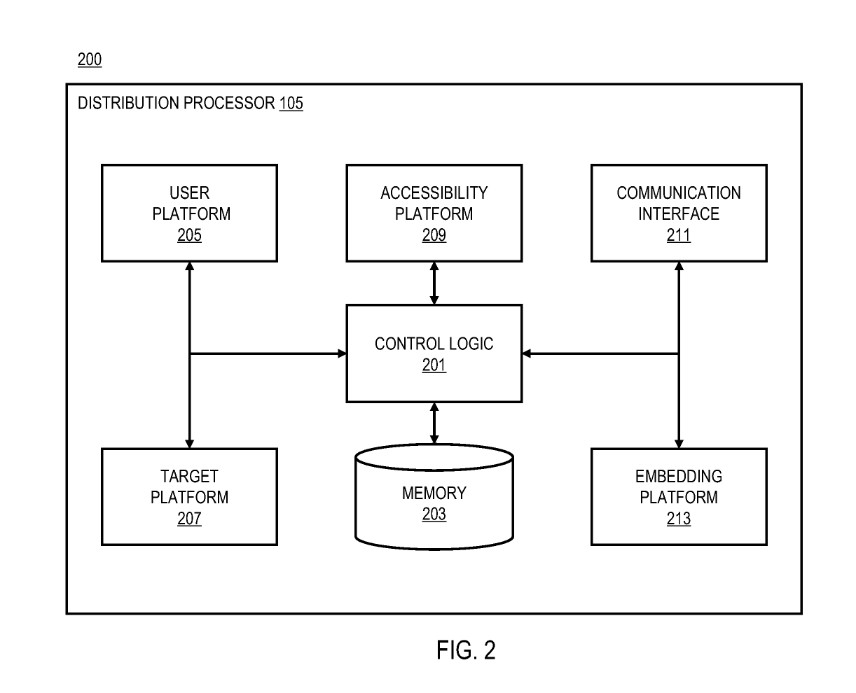

FIG. 2 is a diagram of the components of a distribution processor, according to one embodiment. By way of example, the distribution processor 105 includes one or more components, such as software components or modules, for providing advertisement-to-content item pairing using distribution characteristics. It is contemplated that the functions or features of these components may be combined in one or more components or performed by other components of equivalent functionality. In this embodiment, the distribution processor 105 includes control logic 201, memory 203, user platform 205, target platform 207, accessibility platform 209, communication interface 211, and embedding platform 213.

The control logic 201 may, for instance, receive information from the user platform 205, the target platform 207, and the accessibility platform 209 to determine an optimal content item-advertisement pairing. The user platform 205 may receive user profile information from various UEs 101 via the profile platforms 103. The target platform 207 may receive target audience specifications associated with one or more advertisements from advertisement providers 109. In one embodiment, the target platform 207 may also interact with user platform 205 to provide advertisement providers 109 with statistics of user profiles that have come in contact with a given advertisement. This way, advertisement providers 109 may revise target audience specifications according to distribution characteristics.

The accessibility platform 209 may, for example, calculate the likelihood that one or more content items on one or more UEs 101 will be transmitted to one or more other UEs 101. Then, the control logic 201 may process information received from the user platform 205, the target platform 207, and the accessibility platform 209 to select one or more advertisements (e.g., provided by advertisement providers 109) to pair with one or more content items (e.g., provided by content providers 107). The calculations from the accessibility platform 209 may also help advertisement providers 109 predict users who may see given advertisements and thus permit greater clarity in a target audience.

Then, the embedding platform 213 may embed one or more selected advertisements in one or more content items. The embedding platform 213 may embed advertisements in content items previously lacking advertisements or update and replace existing advertisements embedded in content items. The latter may occur when old advertisements expire, new replacement advertisements are generated, or when distribution characteristics indicate another, more suitable advertisement.

Additionally, the control logic 201 may also utilize the communication interface 211 to communicate with other components of the UEs 101, the profile platforms 103, the distribution processor 105, the content providers 107, the advertisement providers 109, and other components of the system 100. The communication interface 211 may include multiple means of communication. For example, the communication interface 211 may be able to communicate over SMS, interne protocol, instant messaging, voice sessions (e.g., via a phone network), or other types of communication.

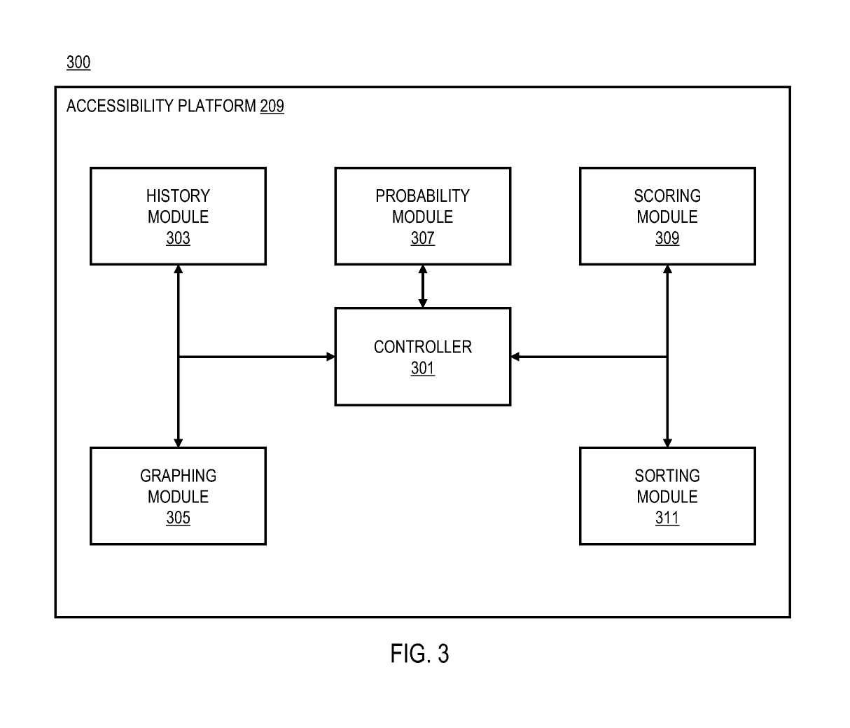

FIG. 3 is a diagram of the components of an accessibility platform, according to one embodiment. By way of example, the accessibility platform 209 includes one or more components, such as software components or modules, for providing the distribution characteristics or features that contribute to pairing advertisements to content items. It is contemplated that the functions of these components may be combined in one or more components or performed by other components of equivalent functionality. In this embodiment, the accessibility platform 209 may include a controller 301, a history module 303, a graphing module 305, a probability module 307, a scoring module 309, and a sorting module 311. The components of the accessibility platform 209 may, for instance, determine distribution characteristics by building one or more connection models, such as connection graphs, between users (e.g., of the UEs 101), calculating content item to user accessibility, and determining one or more content item-advertisement matching scores. The matching scores may then be used, at least in part, to solve an optimization problem to pair advertisements to content items.

In one embodiment, the history module 303 may record and determine content distribution history by determining distribution routes of content items at the server, control logic 201. This may include recording the UEs 101 that download a given content item. In a further embodiment, history module 303 may upload the recorded metadata to the distribution processor 105 when UEs 101 connect to communication network 111 and distribution processor 105. For such a scenario, when UEs 101 connect to each other, their respective history modules 303 may exchange their recorded metadata. Analogously, when UEs 101 connect to distribution processor 105 via the communication network 111, each of the UEs 101 may, for instance, upload all the metadata it has recorded from other UEs 101 to history module 303.

In one embodiment, the graphing module 305 may then build a connection graph based on the content distribution history determined by the history module 303. To build the connection graph, graphing module 305 may determine the strength of the connections between UEs 101. For instance, the strength of the connections (or link strength) between UEs 101 may be contingent on the probability of content transmission between two UEs 101. In other words, two UEs 101 are more strongly connected when there is the high probability of content sharing between the UEs 101, or, there is content frequently shared between UEs 101. For example, in defining each UE 101 as a node, node A may have a total of 10 content items. In sharing 3 of those content items with node B, the link from A to B has a strength value of 3/10, or, 0.3.

Then, the graphing module 305 may work with the probability module 307 to calculate content-user accessibility, or the probability that a given UE 101 may receive a given content item after several rounds of distribution. To do this, probability module 307 may use probability theory. In one embodiment, the probability module 307 may calculate a k-hop content transmission probability matrix as formulated below:

P^{(k)}=pᵢⱼₖ, i=1 . . . L, j≠1 . . . L, i≠j, k≧1

With this formula, the probability module 307 may calculate the probability that a content item will be transmitted from the i-th user to the j-th user in exactly k hops. To calculate pᵢⱼₖ in one embodiment, the probability module 307 may graph all the paths from i to j with length k, then estimate the probability of each path by multiplying all the link strengths in that path according to probability theory:

pᵢⱼₖ≈1−Πₚₐₜₕ_{ₘ}(1−prob(pathₘ))

In one further embodiment, the probability module 307 may calculate the accessibility according to the probabilities where content items have already reached nodes (or UEs 101), and can thus be further distributed. For example, probability module 307 may calculate the accessibility of user i to content c with the formula:

$${p}_{i c} = 1 - {\prod }_{j ∈ J ( c )} {\prod }_{k = 1 - K} ( 1 - {e}^{- ak} {p}_{jik} ) , i ∉ J ( c ) \& {p}_{j} = 1 , j ∈ J ( c )$$

Where J(c) is the set of nodes that already have c(already reached nodes+distribution processor 105), a is a constant to control the decay rate, and K is the maximum number of hops.

Additionally, or alternatively, the probability module 307 may calculate the accessibility according to distribution routes of content items, where link strengths are increased as contents are distributed along the routes. For this, the probability module 307 may update link strengths and re-calculate pᵢⱼₖ with the formula:

pᵢ=1−Π_{k=1 . . . K}(1−e^{-ak}p′ₛᵢₖ)

With this formula, s is the server, or the distribution processor 105.

To take into account the scenario where UEs 101 download only a limited number of content items, the probability module 307 may be modified. For one possible modification, probability module 307 may calculate p_{ic} as described above, but for each user, say, i₀, the probability module may sort the accessibility p_{i0c} in descending order. Then, the probability module 307 may select top k values from p_{i0c}, where k can be a constant, or can be determined based on the number of content items already in the UE 101. Afterwards, the probability module 307 may set p′_{i0c}=p_{i0c} if the latter is within top k values, or p′_{i0c}=0 if not. Based on these calculations, the new is the accessibility.

Once the probability module 307 has calculated accessibility, the controller 301 may cause the scoring module 309 to calculate content item-advertisement matching scores. For each advertisement, respective advertisement providers 109 may define target audience specifications in the form of a user profile, e.g., Female, Age 18-25, Home location in the city of Beijing. From this specification, in one embodiment, the scoring module 309 may pinpoint UEs 101 of targeted users and select these UEs 101. The scoring module 309 may then calculate a content item-advertisement matching score based on the sum of accessibility of the advertisement's targeted users to the content item.

Following the calculating of content item-advertisement matching scores, sorting module 311 may formulate and solve an optimization problem, optimizing the selection of an advertisement with a corresponding content item. For instance, sorting module 311 may be based on one or more optimization problems formulated according to various advertisement revenue models. In one such scenario, an advertisement provider 109 may pay per download by a UE 101 (either from distribution processor 105, or from other UEs 101) if the downloading user belongs to the target audience. Here, for M contents (indexed by i=1 . . . M) and N ads (indexed by j=1 . . . N), probability module 307 may calculate M*N content item-advertisement matching scores. Then, sorting module 311 may define:

bᵢⱼ=1 if the i-th content embeds the j-th advertisement, otherwise bᵢⱼ=0

From there, sorting module 311 may maximize the optimization problem:

ΣᵢΣⱼbᵢⱼmᵢⱼcⱼ, for i=1 . . . M, Σⱼbᵢⱼ≦1

In this case, mᵢⱼ is the matching score and cⱼ is the price of the j-th advertisement. Σⱼbᵢⱼ≦1 given the constraint that one content item may embed at most one advertisement, but such constraints may be adjusted according to the optimization problem defined in each scenario. The sorting module 311 may then solve the optimization problem to yield the “optimal” bᵢⱼ, and thus select the optimal advertisement to be paired with a given content item.

In another scenario, an optimization problem may be formulated where an advertisement provider 109 may pay per download, but the prices for downloads by target UEs 101 and non-targeted UEs 101 are different. This optimization problem may be:

ΣᵢΣⱼbᵢⱼ(cⱼ₁mᵢⱼ+cⱼ₂(mᵢ−mᵢⱼ)), for i=1 . . . M, Σⱼbᵢⱼ≦1

cⱼ₁ may be the price for download by target UEs 101, cⱼ₂ may be the price for download by non-targeted UEs 101, and mᵢ may be the sum of accessibility of all UEs to the i-th content. Again, the sorting module 311 may solve this optimization problem to select an optimal advertisement-content item pairing.

Thus far, the formulas are based on the constraint that each content item may embed, at most, one advertisement. However, the embedding platform 213 may embed multiple advertisements in one content item, given some variations in the optimization problem performed by scoring module 309 and sorting module 311. One possible variation may be formulating the constraint as:

Σⱼbᵢⱼ≦dᵢ

where dᵢ is the capacity of the i-th content, i.e. the maximum number of advertisements that may be embedded. In adjusting the parameters of the optimization problem, changes may be made to the quantity of advertisements embedded in a given content item.

The scoring module 309 and sorting module 311 may, for instance, rely on data gathered over time, such as distribution history. As such, as content providers 107 continuously provide new contents, there is the concern that content item-advertisement pairing for new content items may be inferior to that of older content items. This may occur because there is less distribution history for the new content items. One possible solution is to divide the content items by “old” or “new.” For the newer content items, the controller 301 may discern “similarities” between the newer content item and older content items. One example may include song content items that were composed by the same musician or song content items that are of the same genre, etc. Then, for each advertisement, the scoring module may calculate an average content item-advertisement matching score of “similar” older content items. The matching score of the content item itself and the matching scope of “similar” older contents may then be combined to project an optimal advertisement pairing for the new content item. The assumption is that new content items will fall into distribution routes that reflect distribution routes of the older content items they resemble. Based on this assumption, the advertisement pairings for new content items may quickly become relevant or optimized, despite lacking more distribution information.

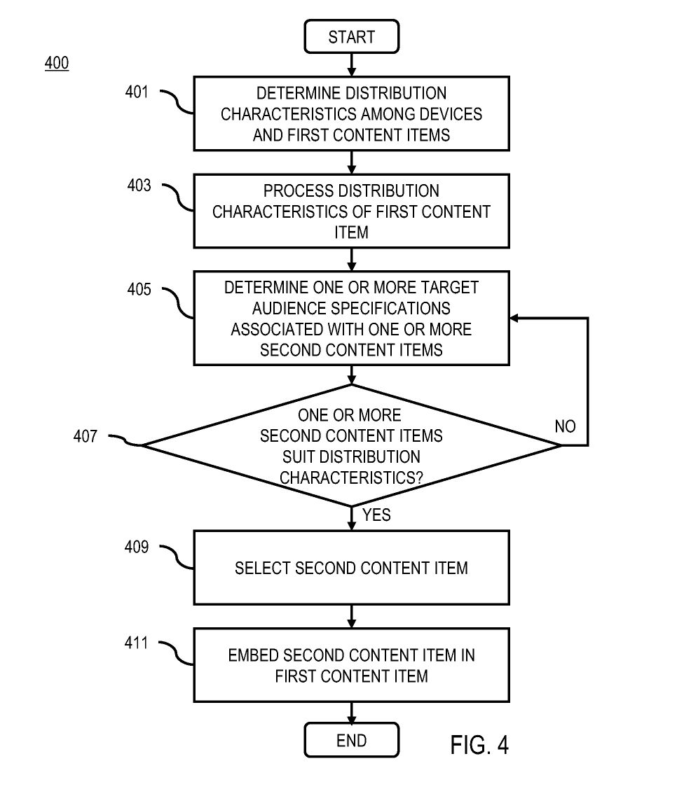

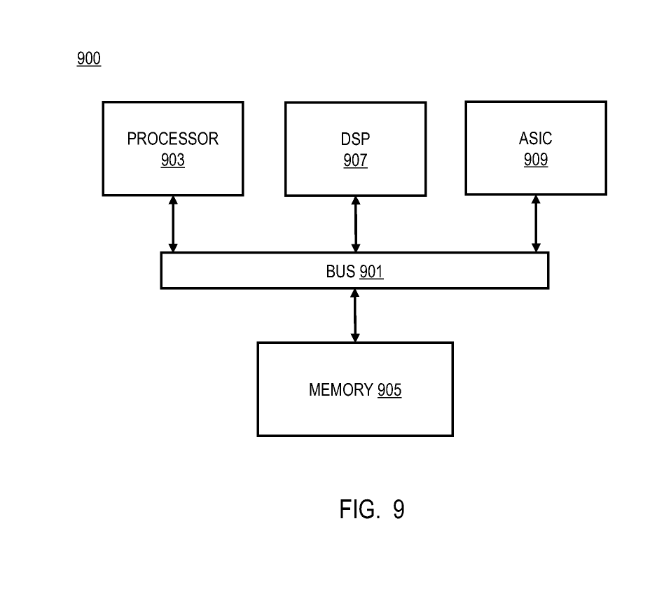

FIG. 4 is a flowchart of a process for pairing advertisements to content items using distribution characteristics for content item distribution, according to one embodiment. In one embodiment, the distribution processor 105 performs the process 400 and is implemented in, for instance, a chip set including a processor and a memory as shown in FIG. 9. In step 401, the distribution processor 105 may determine one or more distribution characteristics of one or more first content items that are distributed among one or more devices (UEs 101). In one embodiment, distribution characteristics may relate to content distribution history or the distribution routes of different contents. For step 403, the distribution processor 105 may process and/or facilitate a processing of the one or more distribution characteristics to cause, at least in part, a selection of one or more second content items. As previously discussed, the one or more second content items may include one or more advertisements.

In one embodiment, step 403 may further comprise of determining user profile information associated with the one or more devices, wherein the selection of the one or more second content items is further based, at least in part, on the user profile information. For this, the user platform 205 may aggregate and supply the control logic 201 with user profile information associated with the one or more devices. In one instance, such user profile information may be provided by the profile platforms 103 of UEs 101, either via request, context information, or any combination thereof.

Then, in step 405, the distribution processor 105 may determine one or more target audience specifications associated with the one or more second content items, wherein the selection of the one or more second content items is further based, at least in part, on the one or more target audience specifications. In one scenario, advertisement target audience specifications may be provided by advertisement providers 109.

For the steps that follow, the distribution processor 105 may process and/or facilitate a processing of the one or more first content items to cause, at least in part, an embedding of the one or more second content items in the one or more first content items. In step 407, the control logic 201 may evaluate how closely target audience specifications (e.g., as provided by advertisement providers 109) align with content item distribution characteristics. In other words, for step 407, the control logic 201 may, for instance, evaluate whether an advertisement will suit the user downloading a content item, based on distribution characteristics associated with the content item. If an advertisement is found suitable, the embedding platform 213 may embed the advertisement in the content item (steps 409 and 411). If not, the accessibility platform 209 may compare another set of advertisement target audience specifications (for another advertisement) to content item distribution characteristics to find a suitable pairing. In one embodiment, the embedding platform 213 may cause, at least in part, a distribution of the one or more first content items with the embedded one or more second content items among the one or more devices via at least one peer-to-peer mechanism.

In one further embodiment, process 400 may include the control logic 201 determining one or more updates to the one or more distribution characteristics, the user profile information, the one or more second content items, the one or more target audience specifications, or a combination thereof, and causing, at least in part, a re-determination of the selection of the one or more second content items based, at least in part, on the one or more updates. For instance, a content item-advertisement relationship may not be consistent throughout an entire system immediately when a server updates a content item-advertisement relationship. An update mechanism could correct such inconsistency wherein new content item-advertisement relationships could replace existing or absent content item-advertisement relationships when UEs 101 connect to the distribution processor 105 or when UEs 101 connect to one another. In one scenario, when UE 101 connects to the distribution processor 105, the distribution processor 105 may embed advertisements into the content item. In an alternate scenario, this same synchronization of advertisements may occur when two UEs 101 connect with one another. The same process may occur whether or not the content item previously had an advertisement embedded in it.

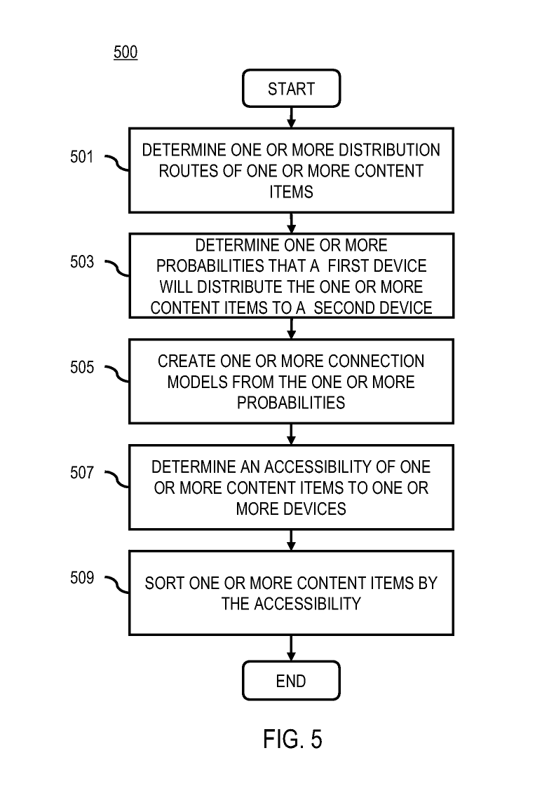

FIG. 5 is a flowchart of a process for determining distribution characteristics of one or more content items, according to one embodiment. In one embodiment, the distribution processor 105 performs the process 500 and is implemented in, for instance, a chip set including a processor and a memory as shown in FIG. 9. As stated previously, the distribution processor 105 may determine one or more distribution characteristics of one or more content items that are distributed among one or more devices. In step 501, the distribution processor 105 may determine one or more distribution routes of the one or more first content items among the one or more devices, wherein the one or more distribution characteristics include, at least in part, the one or more distribution routes. To do this, the distribution processor 105 may, for instance, determine the different distribution routes taken by various content items from servers to UEs 101 and/or between UEs 101.

Then, at step 503, the distribution processor 105 may determine one or more probabilities that a first one of the one or more devices will distribute the one or more first content items to at least a second one of the one or more devices. In one embodiment, the distribution processor 105 cause, at least in part, a creation of one or more connection models among the one or more devices based, at least in part on the one or more probabilities, wherein the one or more distribution characteristics include, at least in part, the one or more connection models (step 505). In one scenario, the distribution processor 105 may determine a number of hops for distributing the one or more first content items from a first one of the one or more devices to at least a second one of the one or more devices, and determine the one or more probabilities based, at least in part, on the number of hops.

Based on the above calculations, the distribution processor 105 may determine an accessibility of the one or more first content items to the one or more devices based, at least in part, on the one or more probabilities, the one or more connection models, the number of hops, or a combination thereof; wherein the one or more distribution characteristics include, at least in part, the accessibility (step 507). The distribution processor 105 may then score content item-advertisement matches according to accessibility to cause, at least in part, a sorting of the one or more first content items based, at least in part on the accessibility, wherein the selection of the one or more second content items is further based, at least in part, on the sorting (step 509). As discussed above, the distribution processor 105 may use various optimization problems to perform the sorting, depending on the optimal pairing defined, at least in part, by advertisement providers 109.

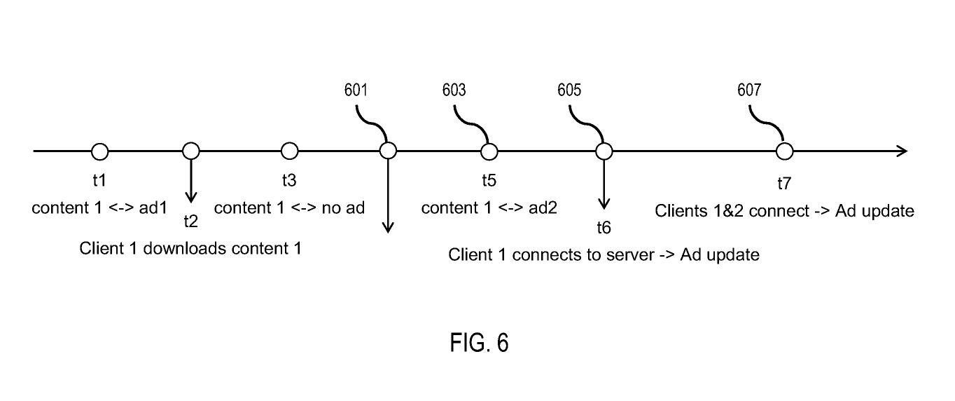

FIG. 6 illustrates an example of the advertisement update process wherein advertisements are synchronized when UE 101 connects to a server (such as distribution processor 105), and again, when UE 101 connects to another UE 101. For instance, in one embodiment, as of time 601, content item 1 is left without any advertisement embedded in it (e.g. a previously embedded advertisement 1 may have expired). At time 603, embedding platform 213 embeds advertisement 2 in content item 1. Thus, when Client 1 (e.g., UE 101) connects to server distribution processor 105 at time 605, Client 1's previously downloaded content 1 is updated to include advertisement 2. Synchronization is further performed at time 607 between UEs 101 when Client 1 and Client 2 connect, and content 1 is updated and/or transmitted to Client 2 containing the embedded advertisement 2.

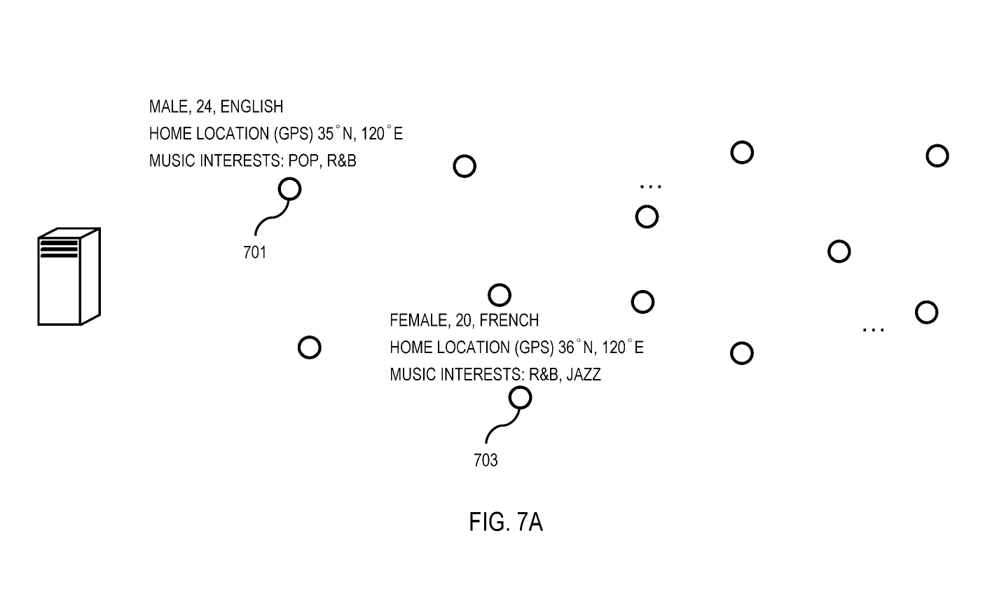

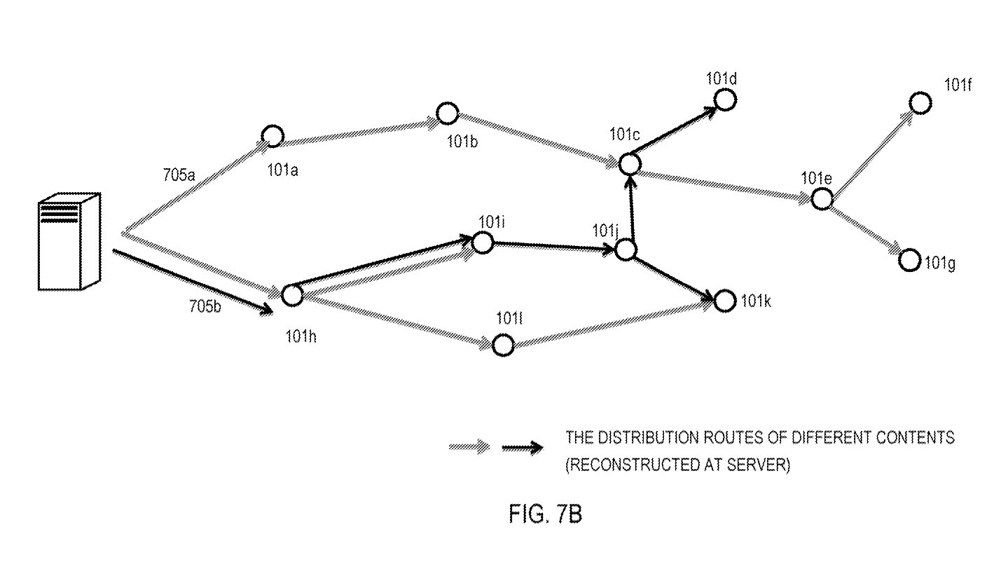

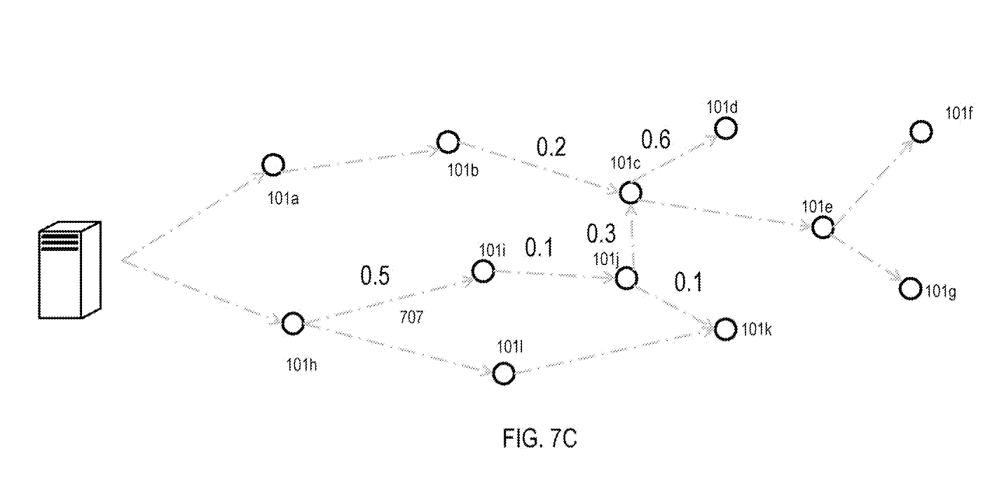

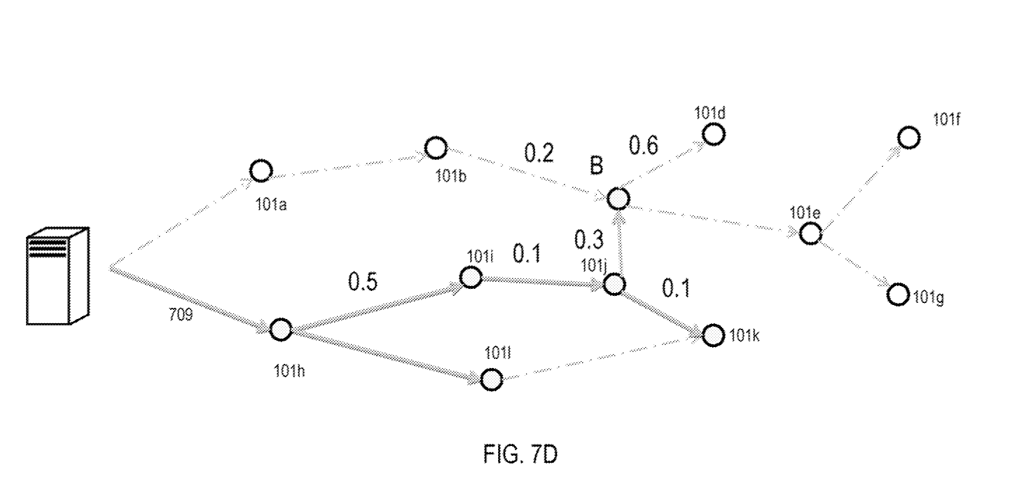

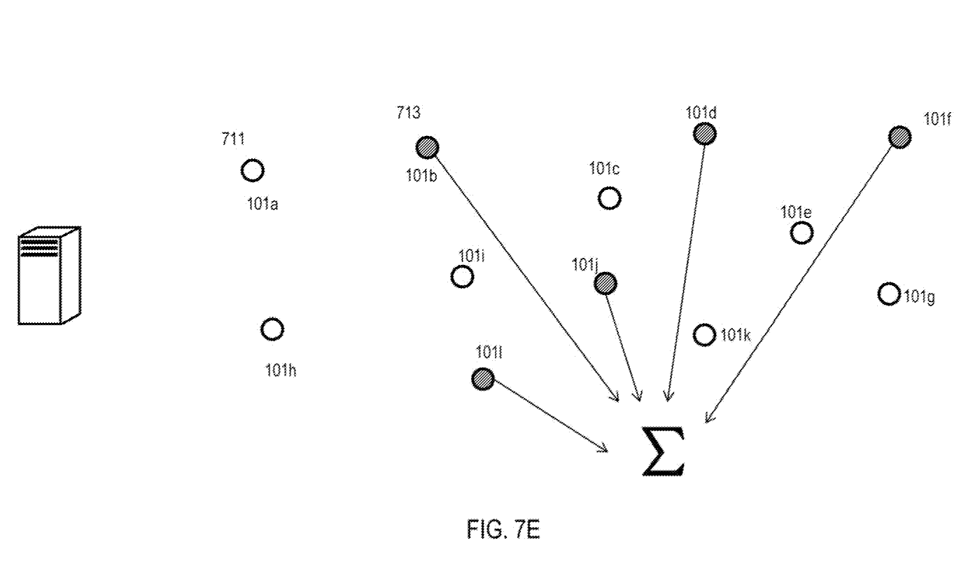

FIGS. 7A-7E are illustrations of the processes of FIG. 5, according to various embodiments. FIG. 7A shows the building of user profiles, wherein each point (e.g., points 701 and 703) represents a UE 101, or end user. By way of example, the profile platforms 103 may contain user profiles associated with respective UEs 101. In one embodiment, user profiles may include basic information regarding a user associated with the one or more UEs 101a-101n, for example, gender, age, language, etc. In one scenario, the profile platforms 103 may directly prompt users to provide the information to build their user profiles. In another scenario, profile platforms 103 may record user context and build user profiles that include information such as user location, interests, preferences, etc. Profile platforms 103 may also use a combination of user responses and context information to build user profiles. One such user profile may be: male, 24, English; home location (GPS) 35°N, 120°E; musical interest: Pop, R&B, as shown by point 701. Another such user profile may be as shown by point 703: Female, 20, French; home location (GPS) 36°N, 120°E; musical interest: R&B, Jazz.

In FIG. 7B, the history module 303 may determine one or more distribution characteristics of one or more content items distributed among the UEs 101. One distribution characteristic may include distribution history in the form of distribution routes. For example, in FIG. 7B, when UE 101c receives a given content item 1 from UE 101b, history module 303 may record, “content item 1: from server->UE 101a->UE 101b.” Likewise, when UE 101e receives content item 1 from UE 101c, it may receive the metadata, “content item 1: from server->UE 101a->UE 101b->UE 101c,” as seen from route 705a. Route 705b illustrates another example route, possibly of a different content item. As previously discussed, history module 303 may then cause an upload of such recorded distribution characteristics to the distribution processor 105 such that the recorded distribution characteristics are exchanged among the UEs 101 that are connected to distribution processor 105.

FIG. 7C gives a possible embodiment where the graphing module 305 starts to create one or more connection graphs among the one or more UEs 101 based on the one or more distribution characteristics. The graphing module 305 may build such a connection graph based on the number of shared items versus total items, between one or more UEs 101. For instance, if the UE 101h has a total of 10 content items and shares 5 of these content items with the UE 101i, their link strength 707 is 0.5. Connection graphs may thus show stronger or weaker link strengths between UEs 101 that frequently share content items, therefore implying a corresponding probability of content sharing and transmission between the UEs 101.

Next, FIG. 7D displays a possible distribution route 709, following the calculations of the graphing module 305 and probability module 307. The probability module 307 may calculate the possible distribution route may be based on the connection graphs and probability theory, as described earlier. Calculations by the probability module 307 may predict the probability that a given content item may be transferred to a given UE 101.

FIG. 7E shows the determination of one or more target audience specifications associated with the one or more advertisements, which scoring module 309 and sorting module 311 may then use in conjunction with distribution characteristics found by the history module 303, graphing module 305, and probability module 307 to select an optimal advertisement for embedding. Based on the specifications, the scoring module 309 may distinguish UEs 101 that fit the target audience specifications 711, over UEs 101 that do not fit target audience specifications 711. Scoring module 309 may then assess the accessibility of a given advertisement's targeted users 713 to yield a content item-advertisement matching score. With the content item-advertisement matching score, the sorting module 311 may better select one or more suitable advertisements to be paired with a given content item.

The processes described herein for pairing advertisements to content items using distribution characteristics may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

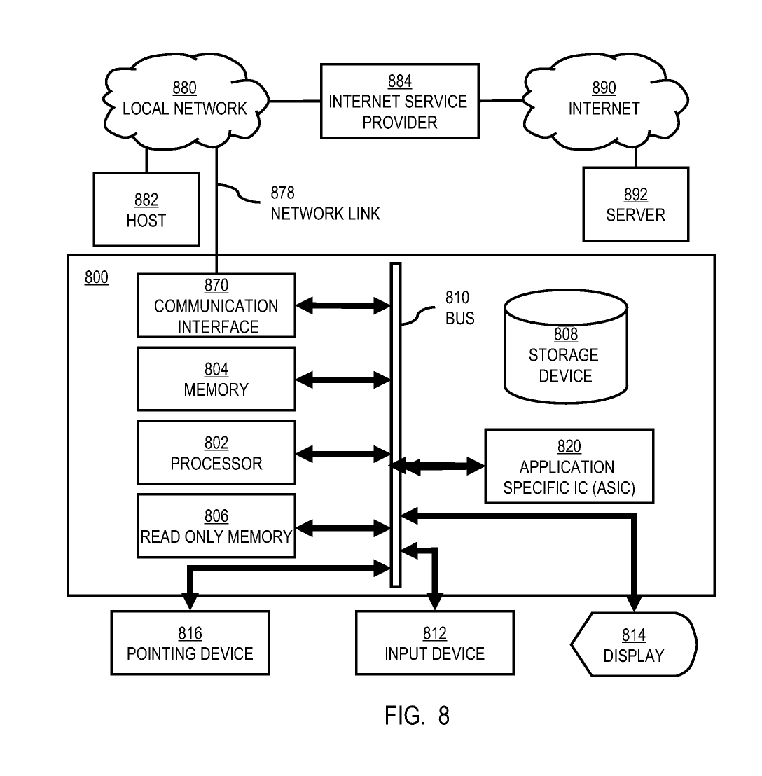

FIG. 8 illustrates a computer system 800 upon which an embodiment of the invention may be implemented. Although computer system 800 is depicted with respect to a particular device or equipment, it is contemplated that other devices or equipment (e.g., network elements, servers, etc.) within FIG. 8 can deploy the illustrated hardware and components of system 8. Computer system 800 is programmed (e.g., via computer program code or instructions) to pairing advertisements to content items using distribution characteristics as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 800, or a portion thereof, constitutes a means for performing one or more steps of pairing advertisements to content items using distribution characteristics.

A bus 810 includes one or more parallel conductors of information so that information is transferred quickly among devices coupled to the bus 810. One or more processors 802 for processing information are coupled with the bus 810.

A processor (or multiple processors) 802 performs a set of operations on information as specified by computer program code related to pairing advertisements to content items using distribution characteristics. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or any other dynamic storage device, stores information including processor instructions for pairing advertisements to content items using distribution characteristics. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or any other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for pairing advertisements to content items using distribution characteristics, is provided to the bus 810 for use by the processor from an external input device 812, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT), a liquid crystal display (LCD), a light emitting diode (LED) display, an organic LED (OLED) display, a plasma screen, or a printer for presenting text or images, and a pointing device 816, such as a mouse, a trackball, cursor direction keys, or a motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of ASICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 111 for pairing advertisements to content items using distribution characteristics to the UE 101.

The term “computer-readable medium” as used herein refers to any medium that participates in providing information to processor 802, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 808. Volatile media include, for example, dynamic memory 804. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 820.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system 800 can be deployed in various configurations within other computer systems, e.g., host 882 and server 892.

At least some embodiments of the invention are related to the use of computer system 800 for implementing some or all of the techniques described herein. According to one embodiment of the invention, those techniques are performed by computer system 800 in response to processor 802 executing one or more sequences of one or more processor instructions contained in memory 804. Such instructions, also called computer instructions, software and program code, may be read into memory 804 from another computer-readable medium such as storage device 808 or network link 878. Execution of the sequences of instructions contained in memory 804 causes processor 802 to perform one or more of the method steps described herein. In alternative embodiments, hardware, such as ASIC 820, may be used in place of or in combination with software to implement the invention. Thus, embodiments of the invention are not limited to any specific combination of hardware and software, unless otherwise explicitly stated herein.

The signals transmitted over network link 878 and other networks through communications interface 870, carry information to and from computer system 800. Computer system 800 can send and receive information, including program code, through the networks 880, 890 among others, through network link 878 and communications interface 870. In an example using the Internet 890, a server host 892 transmits program code for a particular application, requested by a message sent from computer 800, through Internet 890, ISP equipment 884, local network 880 and communications interface 870. The received code may be executed by processor 802 as it is received, or may be stored in memory 804 or in storage device 808 or any other non-volatile storage for later execution, or both. In this manner, computer system 800 may obtain application program code in the form of signals on a carrier wave.

Various forms of computer readable media may be involved in carrying one or more sequence of instructions or data or both to processor 802 for execution. For example, instructions and data may initially be carried on a magnetic disk of a remote computer such as host 882. The remote computer loads the instructions and data into its dynamic memory and sends the instructions and data over a telephone line using a modem. A modem local to the computer system 800 receives the instructions and data on a telephone line and uses an infra-red transmitter to convert the instructions and data to a signal on an infra-red carrier wave serving as the network link 878. An infrared detector serving as communications interface 870 receives the instructions and data carried in the infrared signal and places information representing the instructions and data onto bus 810. Bus 810 carries the information to memory 804 from which processor 802 retrieves and executes the instructions using some of the data sent with the instructions. The instructions and data received in memory 804 may optionally be stored on storage device 808, either before or after execution by the processor 802.

FIG. 9 illustrates a chip set or chip 900 upon which an embodiment of the invention may be implemented. Chip set 900 is programmed to pairing advertisements to content items using distribution characteristics as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 900 can be implemented in a single chip. It is further contemplated that in certain embodiments the chip set or chip 900 can be implemented as a single “system on a chip.” It is further contemplated that in certain embodiments a separate ASIC would not be used, for example, and that all relevant functions as disclosed herein would be performed by a processor or processors. Chip set or chip 900, or a portion thereof, constitutes a means for performing one or more steps of providing user interface navigation information associated with the availability of functions. Chip set or chip 900, or a portion thereof, constitutes a means for performing one or more steps of pairing advertisements to content items using distribution characteristics.

In one embodiment, the chip set or chip 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 900 includes merely one or more processors and some software and/or firmware supporting and/or relating to and/or for the one or more processors.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to pairing advertisements to content items using distribution characteristics. The memory 905 also stores the data associated with or generated by the execution of the inventive steps.

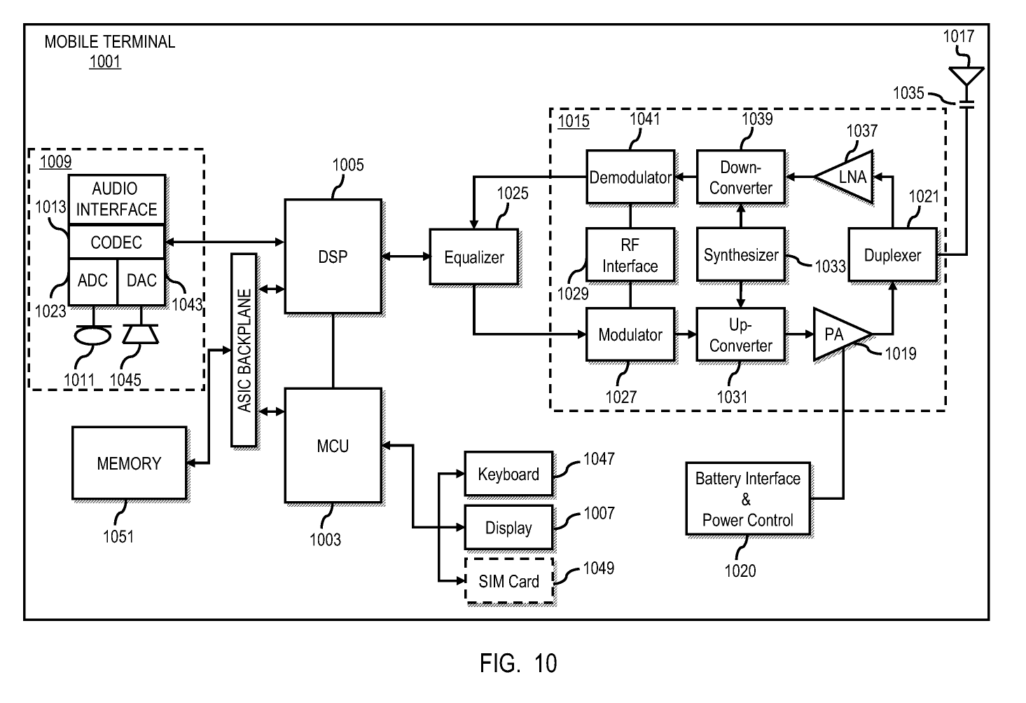

FIG. 10 is a diagram of exemplary components of a mobile terminal (e.g., handset) for communications, which is capable of operating in the system of FIG. 1, according to one embodiment. In some embodiments, mobile terminal 1001, or a portion thereof, constitutes a means for performing one or more steps of pairing advertisements to content items using distribution characteristics. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile terminal functions that perform or support the steps of pairing advertisements to content items using distribution characteristics. The display 1007 includes display circuitry configured to display at least a portion of a user interface of the mobile terminal (e.g., mobile telephone). Additionally, the display 1007 and display circuitry are configured to facilitate user control of at least some functions of the mobile terminal. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile terminal 1001 speaks into the microphone *'11 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003 which can be implemented as a Central Processing Unit (CPU).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile terminal 1001 to pairing advertisements to content items using distribution characteristics. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the terminal. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile terminal 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile terminal 1001 on a radio network. The card 1049 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1-38. (canceled)

39. A method comprising facilitating a processing of and/or processing (1) data and/or (2) information and/or (3) at least one signal, the (1) data and/or (2) information and/or (3) at least one signal based, at least in part, on the following:
determining one or more distribution characteristics of one or more first content items that are distributed among one or more devices;
processing and/or facilitating a processing of the one or more distribution characteristics to cause, at least in part, a selection of one or more second content items;
processing and/or facilitating a processing of the one or more first content items to cause, at least in part, an embedding of the one or more second content items in the one or more first content items.

40. A method of claim 39, wherein the (1) data and/or (2) information and/or (3) at least one signal are further based, at least in part, on the following:
determining user profile information associated with the one or more devices,
wherein the selection of the one or more second content items is further based, at least in part, on the user profile information.

41. A method of claim 40, wherein the (1) data and/or (2) information and/or (3) at least one signal are further based, at least in part, on the following:
determining one or more target audience specifications associated with the one or more second content items,
wherein the selection of the one or more second content items is further based, at least in part, on the one or more target audience specifications.

42. A method of claim 41, wherein the (1) data and/or (2) information and/or (3) at least one signal are further based, at least in part, on the following:
determining one or more updates to the one or more distribution characteristics, the user profile information, the one or more second content items, the one or more target audience specifications, or a combination thereof; and
causing, at least in part, a re-determination of the selection of the one or more second content items based, at least in part, on the one or more updates.

43. A method according to claim 39, wherein the (1) data and/or (2) information and/or (3) at least one signal are further based, at least in part, on the following:
determining one or more distribution routes of the one or more first content items among the one or more devices,
wherein the one or more distribution characteristics include, at least in part, the one or more distribution routes.

44. A method according to claim 39, wherein the (1) data and/or (2) information and/or (3) at least one signal are further based, at least in part, on the following:
determining one or more probabilities that a first one of the one or more devices will distribute the one or more first content items to at least a second one of the one or more devices; and
causing, at least in part, a creation of one or more connection models among the one or more devices based, at least in part on the one or more probabilities,
wherein the one or more distribution characteristics include, at least in part, the one or more connection models.

45. A method of claim 44, wherein the (1) data and/or (2) information and/or (3) at least one signal are further based, at least in part, on the following:
determining a number of hops for distributing the one or more first content items from a first one of the one or more devices to at least a second one of the one or more devices; and
determining the one or more probabilities based, at least in part, on the number of hops.

46. A method of claim 45, wherein the (1) data and/or (2) information and/or (3) at least one signal are further based, at least in part, on the following:
determining an accessibility of the one or more first content items to the one or more devices based, at least in part, on the one or more probabilities, the one or more connection models, the number of hops, or a combination thereof,
wherein the one or more distribution characteristics include, at least in part, the accessibility.

47. A method of claim 46, wherein the (1) data and/or (2) information and/or (3) at least one signal are further based, at least in part, on the following:
causing, at least in part, a sorting of the one or more first content items based, at least in part, on the accessibility,
wherein the selection of the one or more second content items is further based, at least in part, on the sorting.

48. A method according to claim 39, wherein the (1) data and/or (2) information and/or (3) at least one signal are further based, at least in part, on the following:
causing, at least in part, a distribution of the one or more first content items with the embedded one or more second content items among the one or more devices via at least one peer-to-peer mechanism.

49. An apparatus comprising:
at least one processor; and
at least one memory including computer program code for one or more programs,
the at least one memory and the computer program code configured to, with the at least one processor, cause the apparatus to perform at least the following,
determine one or more distribution characteristics of one or more first content items that are distributed among one or more devices;
process and/or facilitate a processing of the one or more distribution characteristics to cause, at least in part, a selection of one or more second content items;
process and/or facilitate a processing of the one or more first content items to cause, at least in part, an embedding of the one or more second content items in the one or more first content items.

50. An apparatus of claim 49, wherein the apparatus is further caused to:
determine user profile information associated with the one or more devices,
wherein the selection of the one or more second content items is further based, at least in part, on the user profile information.

51. An apparatus of claim 50, wherein the apparatus is further caused to:
determine one or more target audience specifications associated with the one or more second content items,
wherein the selection of the one or more second content items is further based, at least in part, on the one or more target audience specifications.

52. An apparatus of claim 51, wherein the apparatus is further caused to:
determine one or more updates to the one or more distribution characteristics, the user profile information, the one or more second content items, the one or more target audience specifications, or a combination thereof; and
cause, at least in part, a re-determination of the selection of the one or more second content items based, at least in part, on the one or more updates.

53. An apparatus according to claim 49, wherein the apparatus is further caused to:
determine one or more distribution routes of the one or more first content items among the one or more devices,
wherein the one or more distribution characteristics include, at least in part, the one or more distribution routes.

54. An apparatus according to claim 49, wherein the apparatus is further caused to:
determine one or more probabilities that a first one of the one or more devices will distribute the one or more first content items to at least a second one of the one or more devices; and
cause, at least in part, a creation of one or more connection models among the one or more devices based, at least in part on the one or more probabilities,
wherein the one or more distribution characteristics include, at least in part, the one or more connection models.

55. An apparatus of claim 54, wherein the apparatus is further caused to:
determine a number of hops for distributing the one or more first content items from a first one of the one or more devices to at least a second one of the one or more devices; and
determine the one or more probabilities based, at least in part, on the number of hops.

56. An apparatus of claim 55, wherein the apparatus is further caused to:
determine an accessibility of the one or more first content items to the one or more devices based, at least in part, on the one or more probabilities, the one or more connection models, the number of hops, or a combination thereof,
wherein the one or more distribution characteristics include, at least in part, the accessibility.

57. An apparatus of claim 56, wherein the apparatus is further caused to:
cause, at least in part, a sorting of the one or more first content items based, at least in part, on the accessibility,
wherein the selection of the one or more second content items is further based, at least in part, on the sorting.

58. An apparatus according to claim 49, wherein the apparatus is further caused to:
cause, at least in part, a distribution of the one or more first content items with the embedded one or more second content items among the one or more devices via at least one peer-to-peer mechanism.

59. An apparatus of claim 49, wherein the apparatus is a mobile phone further comprising:
user interface circuitry and user interface software configured to facilitate user control of at least some functions of the mobile phone through use of a display and configured to respond to user input; and
a display and display circuitry configured to display at least a portion of a user interface of the mobile phone, the display and display circuitry configured to facilitate user control of at least some functions of the mobile phone.

60. A computer-readable storage medium carrying one or more sequences of one or more instructions which, when executed by one or more processors, cause an apparatus to at least perform at least the following:
determining one or more distribution characteristics of one or more first content items that are distributed among one or more devices;
processing and/or facilitating a processing of the one or more distribution characteristics to cause, at least in part, a selection of one or more second content items;
processing and/or facilitating a processing of the one or more first content items to cause, at least in part, an embedding of the one or more second content items in the one or more first content items.
